(19) United States
(12) Patent Application Publication
(10) Pub. No.: US 2026/0251264 A1
(43) Pub. Date: Aug. 27, 2026

(54) HYDROGEN CONTAINMENT VESSEL FOR A TRANSPORT VEHICLE

(71) Applicant: Samuel L. SHEPHERD, Leesville, SC (US)

(72) Inventor: Samuel L. SHEPHERD, Leesville, SC (US)

(21) Appl. No.: 19/536,608

(22) Filed: Feb. 11, 2026

Related U.S. Application Data
(60) Provisional application No. 63/757,112, filed on Feb. 11, 2025.

(51) Int. Cl. F17C 1/00; A62D 1/00; F17C 13/00

(52) U.S. Cl. CPC F17C 1/005; A62D 1/0057; F17C 13/002; F17C 2201/0119; F17C 2201/056; F17C 2203/0636; F17C 2205/0302; F17C 2221/012; F17C 2223/0123; F17C 2223/035; F17C 2260/042; F17C 2265/025

(57) ABSTRACT

A hydrogen containment assembly has an outer container with an interior volume, an inner vessel received within the interior volume of the outer container, and a flame retardant received in the interior volume of the outer container. The inner vessel is adapted receive a hydrogen gas therein. The flame retardant is adapted to reduce the concentration of the hydrogen gas to less than 4% upon a breach of the inner vessel. The inner vessel is formed of a polymer-lined metal material. The flame retardant is a fluorocarbon liquid.

### CROSS-REFERENCE TO RELATED APPLICATIONS

The present application claims priority from U.S. Provisional Patent Application No. 63/757112, filed on Feb. 11, 2025.

### FIELD OF THE INVENTION

The present invention relates to a container that contains hydrogen safely for use in fuel cells, power plants, automobiles, internal combustion engines, and drones. In particular, the present invention relates to hydrogen containment vessels that serve to reduce the flammability or explosive potential of hydrogen leaks during hydrogen storage.

### BACKGROUND OF THE INVENTION

Hydrogen is a revolutionary new type of fuel that has emerged quite recently. As a fuel, hydrogen is abundant, affordable, clean and renewable. The only product of hydrogen reaction with oxygen is water. This is not polluting. Hydrogen can be produced from renewable sources with a virtually nonexistent carbon footprint. Hydrogen fuel cells, which produce electrical power from hydrogen, offer several advantages over petroleum-based internal combustion engines, including water vapor emission, high efficiency, quiet operation, low friction and high energy-to-weight ratio.

Nonetheless, current production, storage and distribution methods of hydrogen are a significant impediment to the widespread use of hydrogen as an alternative energy source. The most common method of hydrogen distribution involves producing hydrogen gas, liquefying or pressurizing the hydrogen into a pressurized cylinder, shipping the cylinders to the point of use, and releasing the hydrogen from the cylinders. Hydrogen is flammable over a wide range of concentrations in air and has low spark temperatures. Thus, storage, distribution and use of hydrogen in tanks has to be highly regulated and controlled. Hydrogen tanks are often heavy and contain specialized explosion-proof components. As a result, they are relatively expensive due to the need to provide the necessary safety measures. Nevertheless, even with these precautions, there is still a significant risk that hydrogen may be released and explode during loading, unloading, distribution or use. This can be the result of accidents or vandalism. Such risks render it an unfavorable approach toward powering motorized vehicles.

Compressed hydrogen has one of the highest densities existing and also the widest explosive, ignition mix range with air of all gases (4% to 80% volume) with few exceptions, such as acetylene, silane, and ethylene oxide. Ignition energy is extremely low and has a low probability of being circumvented. A very minimum amount of energy and mixture ratio is needed in order for an explosion to occur. That means that whatever the mix proportion between air and hydrogen, when ignited in an enclosed space, a hydrogen leak will most likely lead to an explosion and not a mere flame.

There are many codes and standards regarding hydrogen safety in storage, transport and use. These range from federal regulations, such as ANSI/AIAA, [4] NFPA, and ISO standards. The Canadian Hydrogen Safety Program concluded that hydrogen fueling is as safe as, or safer than, compressed natural gas fueling. There are a number of items to consider to when designing systems and procedures to avoid accidents when dealing with hydrogen. One of the primary dangers of hydrogen is that it is extremely flammable. As such, a need has developed so as to mitigate the explosiveness or flammability of the hydrogen gas.

In the past, various patents and patent application publications have issued with respect to such hydrogen fuel tanks and the control of explosions associated therewith. For example, U.S. Pat. No. 6,418,962, issued on Jul. 16, 2002 to Wozniak et al., shows a compressed gas vehicle fuel storage system comprised of a plurality of compressed gas pressure cells supported by shock-absorbing bumpers positioned within a shape-conforming container. The container is dimensioned relative to the compressed gas pressure cells whereby a radial air gap surrounds each compressed gas pressure cell. The radial air gap allows pressure-induced expansion of the pressure cells without resulting in the application of pressure to adjacent pressure cells or physical pressure to the container.

U.S. Pat. No. 7,137,474, issued on Nov. 21, 2006 to M. Yokote, describes a support structure for a container of hydrogen gas. This support structure has neck portions on both ends of a longitudinal dimension thereof. A first support member supports one of the neck portions of the container. A second support member that supports the other of the neck portions of the container and elastically presses the container in the longitudinal direction thereof. The first and second support members are fixed to a frame.

U.S. Pat. No. 7,858,068, issue on Dec. 28, 2010 to Fuller et al., teaches a method of storing and generating hydrogen for fuel cell applications. This method includes providing a dry, solid-state hydrogen fuel source with a solid metal hydride or chemical hydride and a reaction-controlling agent in a solid state. The hydride and the reaction-controlling agent are mixed at a desired proportion. A desired amount of liquid reacted is delivered to contact and react with the solid-state fuel source so as to produce hydrogen gas continuously or intermittently on demand.

U.S. Pat. No. 7,947,119, issued on May 24, 2011 to Golz et al., provides a hydrogen reservoir having a housing with a hydrogen storage material arranged in the housing for absorbing and releasing hydrogen, as needed. The hydrogen reservoir includes at least one unit having a porous body surrounding a container in which the hydrogen storage material is contained. A method is provided for charging the hydrogen reservoir with hydrogen from a hydrogen filling station.

U.S. Pat. No. 8,186,315, issued on May 29, 2012 to Jeffs et al., discloses a hydrogen fuel system for an internal combustion engine. This hydrogen fuel system includes a water reservoir and a fluid cell in fluid communication with the water reservoir. An oxygen line is fluidly coupled to the hydrogen fuel cell and receives and transports oxygen away from the fuel cell. A hydrogen line is fluidly coupled to the fuel cell and receives and transports hydrogen away from the fuel cell. A hydrogen gas interface is fluidly coupled to the oxygen line and the hydrogen line and is operatively coupled to an engine intake.

U.S. Pat. No. 8,628,609, issued on Jan. 14, 2015 to F. Ornath, shows a hydrogen-containing tank having an inside wall that is uniquely bonded to a hydride core which is a porous hydrogen-containing core material. The high hydrogen content capability and high thermal conductivity properties accommodate a rapid release and intake of hydrogen gas.

U.S. Pat. No. 11,525,544, issued on Dec. 13, 2022 to Clarke et al., discloses a fuel storage module assembly. This has a hydrogen storage vessel that has an inner body and an outer body structured as concentric rings with a conic interface. The vessel has four material layers, including a barrier layer, an insulation layer, a fiber knit, and an abrasion layer. The fiber knit is braided to trap the hydrogen.

U.S. Patent Application Publication No. 2004/0016769, published on Jan. 29, 2004 to S. D. Redmond, teaches hydrogen storage, distribution and recovery. A cassette contains a hydrogen storage material from which hydrogen may be recovered in a hydrogen recovery system. The cassette is distributed through a common carrier as a non-hazardous material.

U.S. Patent Application Publication No. 2009/0272590, published on Nov. 5, 2009 to Kim et al., provides a hydrogen storage system for a vehicle which is readily attachable to and detachable from the vehicle. The hydrogen storage system includes a plurality of hydrogen tanks filled with hydrogen at the outside. The hydrogen storage system is mounted on the top of a rear underfloor of the vehicle in the form of a cartridge.

U.S. Patent Application Publication No. 2019/0047411, published on Feb. 14, 2019 to Kataoka et al., shows a high-pressure canister unit that includes a plurality of arrayed canister bodies. Each canister body is formed in a circular cylindrical shape. Each canister body includes an opening at one end. A coupling member is connected to the opening so as to couple the plurality of canister bodies together. The coupling member includes a flow path placing interiors of the canister bodies in communication with each other.

U.S. Patent Application Publication No. 2023/0402629, published on Dec. 14, 2023, to Sessions et al., provides a solid hydrogen storage material in the form of a metal hydride. The pressure of a hydrogen storage tank controls the release of hydrogen from a solid hydrogen storage material.

European Patent No. 4 303 427, published on Jan. 10, 2024 to N. Ito, discloses an on-vehicle hydrogen supply apparatus that includes a hydrogen supply unit that includes a liquid hydrogen tank, a vaporizer that vaporizes liquid hydrogen, and a pressure chamber that is filled with vaporized hydrogen gas and supplies the filled hydrogen gas to a hydrogen engine for driving a vehicle.

It is an object of the present invention to provide a hydrogen containment vessel that reduces or eliminates explosiveness or flammability of hydrogen fuel.

It is another object of the present invention to provide a hydrogen containment vessel that dilutes hydrogen to less than 4% upon a leak or containment breach.

It is another object of the present invention to provide a hydrogen containment vessel that reduces embrittlement.

It is another object of the present invention to provide a hydrogen containment vessel that mitigates the explosiveness or flammability of hydrogen gas.

It is still another object of the present invention to provide a hydrogen containment vessel that minimizes the risk of containment breach.

These and other objects and advantages of the present invention will become apparent from a reading of the attached specification and appended claims.

### SUMMARY OF THE INVENTION

The present invention is a hydrogen containment assembly that comprises an outer container having an interior volume, an inner vessel received within the interior volume of the outer container, and a flame retardant received in the interior volume of the outer container. The inner vessel is adapted to receive a hydrogen gas therein. The flame retardant is adapted to reduce a concentration of the hydrogen gas to less than 4% upon a breach of the inner vessel.

The outer container is formed of a metal material. The outer container has a pressure rating of greater than 500 p.s.i.a. The outer container has an inlet formed therein. This inlet has a fitting adapted to allow the flame retardant to be introduced into the interior volume of the outer container.

The inner vessel is formed of a polymer-lined metal material. The inner vessel has a pressure rating of greater than 500 p.s.i.a. The inner vessel has an inlet and an outlet. Each of the inlet and the outlet open to an interior volume of the inner vessel. Each of the inlet and the outlet are accessible from an exterior of the outer container. Each of the inlet and the outlet of the inner vessel has a threaded fitting thereon. The inlet is adapted to introduce hydrogen into an interior of the inner vessel. The outlet is adapted to allow hydrogen to be removed from the inner vessel.

The inner vessel has a volume of less than three cubic feet. The interior volume of the outer container is less than one cubic foot in a space exterior to that of the inner vessel.

The flame retardant is a fluorocarbon liquid. In the preferred embodiment, this fluorocarbon liquid is a halon fire suppressant. The fire retardant is at a pressure of greater than 100 p.s.i.a. The hydrogen gas will be at a pressure of between 500 p.s.i.a. and 7000 p.s.i.a. In an embodiment of the present invention, the inner vessel will be a cylindrical storage bullet having a length of approximately four feet and a diameter of approximately six inches.

This foregoing Section is intended to describe, with particularity, the preferred embodiments of the present invention. It is understood that modifications to these preferred embodiments can be made within the scope of the present claims. As such, this Section should not be construed, in any way, as limiting of the broad scope of the present invention. The present invention should only be limited by the following claims and their legal equivalents.

### BRIEF DESCRIPTION OF DRAWINGS

FIG. 1 is a cross-sectional view showing the hydrogen containment assembly of the present invention.

### DETAILED DESCRIPTION OF THE INVENTION

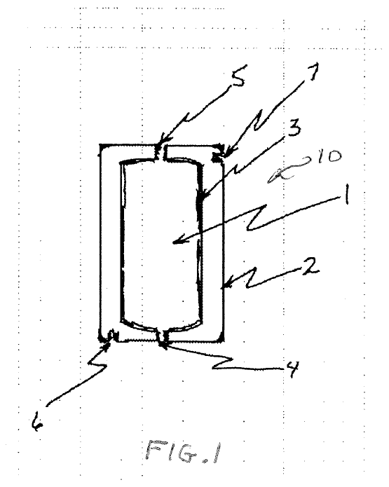

Referring to FIG. 1, there is shown the hydrogen containment assembly 10 for reducing or eliminating the explosiveness or flammability of hydrogen when the hydrogen is used as a fuel. It is important to note that hydrogen is not flammable below 4% by volume in air. It is the purpose of the present invention to dilute the hydrogen using an inert fire retardant. This dilution is to be less than 4% by volume upon a leak or a containment breach.

The present invention includes a polymer-lined metal inner vessel 1 having filling and discharge nozzles 4 and 5. The polymer-lined metal vessel has a rated pressure of greater than 500 p.s.i.a. This inner vessel 1 is contained within and is a component of an outer metal container 2 having a pressure rating of greater than 500 p.s.i.a. The inner vessel 1 has a hydrogen gas therein. This hydrogen gas is at a pressure of between 500 p.s.i.a. to 7000 p.s.i.a. The container 2 receives a flame-retardant material in the space between the exterior of the inner vessel 1 and the inner wall of the outer container 2. This flame retardant will also entirely surround the exterior wall 3 of the inner vessel 1. The flame retardant is composed of a fluorocarbon liquid material similar to that of a halon-type fire suppressant. The outer vessel includes an inlet 6 and an outlet 7. Each of the inlets 6 and 7 of the outer container 2 includes a metal fitting adapted to join with pipes that are necessary to install the fire-retardant liquid into the interior volume of the outer container 2 or to remove any fire retardant material (with or without exposed hydrogen) from the interior of the outer container 2. Similarly, the inner vessel 1 has in the inlet 4 and outlet 5, in which metal fittings are received, so as to transport the hydrogen gas into the interior volume of the inner vessel 1 or out of the interior volume of the inner vessel 1.

The use of the inerting material (such as the flame retardant) is a viable solution to the problem posed by rapid hydrogen container breach. In order to properly inert, or purge, the flammability limits must be taken into account. The flammability limits of hydrogen are very different from other types of gases. These flammability limits are approximately 4% to 80% at normal atmospheric pressure based upon the volume percent of hydrogen in the atmosphere. In fact, these flammability limits can be often more stringent than this. Since the turbulence during a fire can cause a deflagration which can create a detonation. For comparison, the deflagration limit of gasoline in air is 1.5% to 7.6%. It is 2.5% to 82% for acetylene in air. Therefore, the present invention provides container of hydrogen, under pressure, such that upon breach, the self-contained fire retardant will suppress the hydrogen volume in air to less than 4% volume. The present invention also provides a container that minimizes the risk of container breach, hydrogen embrittlement, high-temperature hydrogen attack, and passive autocatalytic recombiner. As such, the present invention requires that the container be lined with a polymeric material that is impervious to hydrogen diffusion. As a result, the present invention results in both decreased flammability and reduced hydrogen diffusion. The present invention also mitigates this risk through the risk of a possibility of a leak, the possibility of an ignition, and a reduction of fuel-to-oxygen ratio to below explosive limits.

There are four main chemical properties to account for when dealing with hydrogen when the hydrogen comes into contact with other materials (even in normal atmospheric pressures and temperatures). The first main chemical property is that the chemistry of hydrogen is very different from traditional chemicals, e.g. with oxidation when in ambient environments. The hydrogen can be generated as a byproduct of a different reaction that may be overlooked, e.g. zirconium and steam that creates a source of hydrogen. This danger can be circumvented somewhat through the use of passive autocatalytic recombiners.

Secondly, another major issue to consider is the chemical compatibility of hydrogen with other common building materials, such as steel. Because of hydrogen embrittlement, material compatibility with hydrogen is important to consider. These considerations can further change because of special reactions at high temperatures. The deep diffusivity of hydrogen is very different from other gases. Therefore, gasketing materials need to be chosen very carefully. The buoyant forces and stresses on mechanical bodies involved are often reverse from that of standard gases. For example, because of buoyancies, stresses are often more pronounced near the top of a large storage tank.

The present invention of compressed hydrogen storage has three main components: the hydrogen storage inner vessel, the flame-retardant outer container, and the flame retardant liquid component. The gaseous hydrogen is usually not stored at pressures exceeding 500 bar in the above.

The achievable hydrogen storage densities, at 100 bar and 20° C., is approximately 7.8 kg/m³. This low hydrogen density leads to large storage and, thus, high investment costs. Therefore, it is the intention to store hydrogen for use at pressures greater than 100 bar. The use of a metal inner vessel ensures stability of storage and the purity of the stored hydrogen. It also reduces the explosive risk. The consequences of this stored hydrogen, and the explosive risks associated therewith, can be applied independently of location. As such, the present invention reduces the risk of imminent injury from a container breach by the storage of hydrogen in metallic vessels.

Three main types of metallic vessels are currently used for the storage of larger amounts of hydrogen. These include spherical bottles with a maximum storage pressure of up to 50 bar. Secondly, pipe storage has a maximum storage pressure of approximately 300 bar. Thirdly, bullet storage with that has a maximum storage pressure of approximately 500 bar. Due to the higher storage pressure of hydrogen, the most promising option among these for the storage of hydrogen seems to be the storage bullets or containers.

The construction of a storage bullet is relatively simple. It is a series of relatively short tanks having dimensions of no more than twelve inches in diameter and four feet in length. These are laid down with sealed ends. The insides of the tanks are lined with a polymeric material that serves as a barrier between the hydrogen and the metallic wall surface.

The filling capacity of the bullets/cylinders are determined by the volume and pressure based upon the fundamental gas law defined by:
n=RT/PV
Where, n=number of moles of hydrogen contained in the bullet/cylinder
R=universal gas constant
T=Temperature
P=pressure
V=volume of the bullet/cylinder (V=3.14×r\hat{ }2×length of cylinder)
   For example, a six-inch diameter cylinder of four feet in length and pressurized to 3300 p.s.i.a., will fuel a hybrid vehicle for well over 800 miles. This assumes 25% ICE efficiency.

The foregoing disclosure and description of the invention is illustrative and explanatory thereof. Various changes in the details of the illustrated construction can be made within the scope of the present invention without departing from the true spirit of the invention. The present invention should only be limited by the following claims and their legal equivalents.

1. A hydrogen containment assembly comprising:
an outer container having an interior volume;
an inner vessel received within the interior volume of said outer container, said inner vessel adapted to receive a hydrogen gas therein; and
a flame retardant received in the interior volume of said outer container, said flame retardant adapted to reduce the concentration of the hydrogen gas to less than 4% upon a breach of said inner vessel.

2. The hydrogen containment assembly of claim 1, said outer container being formed of a metal material.

3. The hydrogen containment assembly of claim 2, said outer container having a pressure rating of greater than 500 p.s.i.a.

4. The hydrogen containment assembly of claim 1, said outer container having an inlet formed thereon, the inlet being a fitting adapted to allow the flame retardant to be introduced into the interior volume of said outer container.

5. The hydrogen containment assembly of claim 1, said inner vessel being formed of a polymer-lined metal material.

6. The hydrogen containment assembly of claim 1, said inner vessel having a pressure rating of greater than 500 p.s.i.a.

7. The hydrogen containment assembly of claim 1, said inner vessel having an inlet and an outlet, each of the inlet and the outlet opening to an interior volume of said inner vessel, each of the inlet and the outlet being accessible from an exterior of said outer container.

8. The hydrogen containment assembly of claim 7, wherein each of the inlet and the outlet of said inner vessel is a threaded fitting, the inlet adapted to introduce hydrogen into an interior volume of said inner vessel, the outlet adapted to allow hydrogen to be removed from the inner vessel.

9. The hydrogen containment assembly of claim 1, wherein said inner vessel has a volume of less than three cubic feet, the interior volume of said outer container being less than one cubic foot in a space exterior of said inner vessel.

10. The hydrogen containment assembly of claim 1, said flame retardant being a fluorocarbon liquid.

11. The hydrogen containment assembly of claim 10, the fluorocarbon liquid being a halon fire suppressant.

12. The hydrogen containment assembly of claim 1, said flame retardant being at a pressure of greater than 100 p.s.i.a.

13. The hydrogen containment assembly of claim 1, wherein the hydrogen gas is at a pressure of between 500 p.s.i.a. and 7000 p.s.i.a.

14. The hydrogen containment assembly of claim 1, wherein said inner vessel is a cylindrical storage bullet having a length of approximately four feet and a diameter of approximately six inches.

15. A hydrogen containment assembly comprising:
an outer container having an interior volume;
an inner vessel received within the interior volume of said outer container, said inner vessel adapted to receive a hydrogen gas therein, said inner vessel being formed of a polymer-lined metal material;
a flame retardant received in the interior volume of said outer container, said flame retardant adapted to reduce the concentration of the hydrogen gas to less than 4% upon a breach of said inner vessel; and
a hydrogen gas received within said inner vessel, said hydrogen gas having a pressure of between 500 p.s.i.a. and 7000 p.s.i.a.

16. The hydrogen containment assembly of claim 15, wherein said inner vessel has an inlet and an outlet, each of the inlet and the outlet opening to an interior volume of said inner vessel, each of the inlet and the outlet being accessible from an exterior of said outer container.

17. The hydrogen containment assembly of claim 16, wherein each of the inlet and the outlet of said inner vessel has a threaded fitting, the inlet being adapted introduce said hydrogen into an interior of said inner vessel, the outlet adapted to allow the hydrogen to be removed from the inner vessel.

18. The hydrogen containment assembly of claim 15, said flame retardant being a fluorocarbon liquid.

19. The hydrogen containment assembly of claim 18, wherein said flame retardant is of a pressure of greater than 100 p.s.i.a.

20. The hydrogen containment assembly of claim 15, wherein said outer container is formed of a metal material.
